(19) United States
(12) Patent Application Publication
(10) Pub. No.: US 2022/0319771 A1
(43) Pub. Date: Oct. 6, 2022

(54) INTELLIGENT CONTROL METHOD AND SYSTEM FOR FULLY AUTOMATIC BONDING OF TALC PILL

(71) Applicant: Shandong Power Equipment Co., Ltd., Jinan, Shandong (CN)

(72) Inventors: Zhiwei Han, Jinan, Shandong (CN); Feidong Yan, Jinan, Shandong (CN); Zihong Yan, Jinan, Shandong (CN); Jiankai Xi, Jinan, Shandong (CN); Zhenyuan Yang, Jinan, Shandong (CN); Jingtong Zhang, Jinan, Shandong (CN); Fayong Li, Jinan, Shandong (CN); Hui Xie, Jinan, Shandong (CN); Shihua Jiang, Jinan, Shandong (CN); Xiaolin Chen, Jinan, Shandong (CN)

(21) Appl. No.: 17/601,078

(22) PCT Filed: Aug. 9, 2021
(86) PCT No.: PCT/CN2021/111437

§ 371 Date: Oct. 3, 2021

(30) Foreign Application Priority Data
Jun. 11, 2020 (CN) 202010533338.9

(51) Int. Cl. H01F 41/02

(52) U.S. Cl. CPC H01F 41/0206

(57) ABSTRACT

An intelligent control method for fully automatic bonding of a talc pill includes: automatically identifying, by an image recognition module, the specification and type of a silicon steel sheet to be processed, calling a corresponding bonding trajectory planning path of a talc pill according to the specification and type of the silicon steel sheet, and automatically bonding, by a manipulator automatic control module, the talc pill to a corresponding position on the silicon steel sheet according to the bonding trajectory planning path. The present disclosure further relates to an intelligent control system for fully automatic bonding of a talc pill. The intelligent control method and system of the present disclosure realize the fully automatic bonding of talc pills, and ensure the fastness and accuracy of the bonding of the talc pills. The application of the present disclosure greatly improves production efficiency, and can completely replace manual operation.

### TECHNICAL FIELD

The present disclosure belongs to the technical field of transformer production, and in particular relates to an intelligent control method and system for fully automatic bonding of a talc pill, which can automatically identify a position of the talc pill, capture the talc pill and place the talc pill in a designated position for bonding, where the automatic identification of the position of the talc pill relates to the field of image processing and visual identification, and the capture and placement of the talc pill relates to the field of manipulator pose and force control.

### BACKGROUND

The external core oil passage of a large power transformer or a converter transformer is formed by bonding talc pills to silicon steel sheets. At present, the talc pills are bonded by hand, which is time-consuming, laborious and cumbersome. In addition, since the amount of glue is not fixed and the force is uneven, the talc pill may fall off after assembly, and the glue may overflow.

Chinese patent “AUTOMATIC BONDING DEVICE OF TALC PILL” (CN106169366A) realizes the automatic bonding of talc pills. However, in this patent, the control method of the programmable logic controller (PLC) and the manipulator control still need to be further optimized.

### SUMMARY

In order to solve the above technical problems, the present disclosure proposes an intelligent control method and system for effectively and accurately controlling a manipulator to accurately, quickly and uniformly bond a talc pill to a silicon steel sheet. In view of this, the present disclosure adopts the following technical solution:

An intelligent control method for fully automatic bonding of a talc pill includes:

automatically identifying, by an image recognition module, a specification and type of a silicon steel sheet to be processed, calling a corresponding bonding trajectory planning path of a talc pill according to the specification and type of the silicon steel sheet, and automatically bonding, by a manipulator automatic control module, the talc pill to a corresponding position on the silicon steel sheet according to the bonding trajectory planning path.

Preferably, the intelligent control method may include the following steps:

step 1: preliminary manual preparation: placing talc pills, glue and the silicon steel sheet in position;

step 2: starting devices of an intelligent control system for fully automatic bonding to complete initialization of the system;

step 3: starting a high-brightness and uniform light-emitting diode (LED) light source to acquire an image of the silicon steel sheet, detecting and identifying the specification and type of the silicon steel sheet, calling a corresponding bonding trajectory planning path of each of the talc pills according to the specification and type of the silicon steel sheet, and performing edge detection on the silicon steel sheet according to the acquired image to determine a position to place a first talc pill;

step 4: automatically starting the bonding of the first talc pill until the bonding of a first column of talc pills is completed; and

step 5: automatically starting the bonding of the following columns of talc pills until the bonding of the talc pills of the entire silicon steel sheet is completed.

Preferably, step 3 may further include: determining whether the identified specification and type of the silicon steel sheet are a known specification and type; if yes, calling an existing bonding workflow for automatic bonding of the talc pills; and if not, setting a new bonding workflow according to the new specification and type of the silicon steel sheet, and calling the newly set bonding workflow for automatic bonding of the talc pills.

Preferably, step 4 may further include: conveying a single talc pill through a vibration of a barrel to a fetching port via a spiral slideway and a linear slideway in sequence; driving, by a vertical manipulator, a vacuum adsorber to go down under the action of a motor, and adsorbing, by a suction nozzle, the talc pill up; driving, by compressed air, a glue nozzle to spray quantitative glue up to the bottom of the talc pill and automatically suck excess glue back; extending a horizontal manipulator horizontally to move the talc pill to a position above the silicon steel sheet; driving, by the vertical manipulator, the vacuum adsorber to press the talc pill down onto the silicon steel sheet; and releasing the talc pill after maintaining a pressure for 200 ms, thereby completing the bonding of the first talc pill.

Preferably, step 4 may further include: determining whether a current talc pill is placed successfully according to an acquired image; setting a maximum number of placements; and alarming and shutting down if a number of placements exceeds the set maximum number of placements; step 5 may further include: stopping the bonding work when an end angle of the silicon steel sheet is detected; and sounding a buzzer to remind an operator to take out the completed silicon steel sheet and place a new silicon steel sheet to continue bonding.

Preferably, the method further comprises setting an exception handling module; wherein the exception handling module may be configured to: alarm and shut down if a motor is over-voltage, over-current, or a mechanical device goes beyond an edge of the silicon steel sheet, or the talc pill falls off for many times, or the talc pills in the barrel are insufficient; re-fetch a talc pill if the talc pill is not successfully adsorbed or falls off; and control the placement of the talc pill to meet a distance value from the edge of the silicon steel sheet if the talc pill reaches the edge.

An intelligent control system for fully automatic bonding of a talc pill, applies the above intelligent control method for fully automatic bonding of a talc pill, and includes: a hardware processing module, where the hardware processing module is electrically connected to a signal acquisition module; the signal acquisition module is electrically connected to a main program control module; the main program control module is electrically connected to a host computer and a drive circuit respectively; the drive circuit is electrically connected to an actuator.

Preferably, the main program control module may include: a programmable logic controller (PLC), an image processing and recognition module, a manipulator pose control module, a manipulator force control module and a machine vision positioning module;

the PLC may be provided on a main pulley, and may be configured to implement corresponding algorithms of the image processing and recognition module, the manipulator pose control module, the manipulator force control module and the machine vision positioning module;

the image processing and recognition module is configured to acquire characteristic data through image processing, and determine the specification, type and an edge position of the silicon steel sheet;

the manipulator pose control module is configured to control a horizontal manipulator to run stably to a specified position;

the manipulator force control module is configured to adopt a direct torque control algorithm to control a vertical movement status of a vertical manipulator and control the vertical manipulator to ensure a stable output torque;

the machine vision positioning module may be configured to determine an initial working position and a position to place the last talc pill in each row.

Preferably, the signal acquisition module may include: an image acquisition device, a position sensor, a pressure sensor and a voltage and current sensor;

the position sensor may be located at a drive motor of a manipulator and may be provided coaxially with the drive motor; the position sensor may be configured to feed back a current position of the manipulator to realize closed-loop control of the position of the manipulator, incrementally record a current movement distance by using an encoder and calculate the current position;

the pressure sensor may be provided in the vertical manipulator, and may be configured to ensure a proper pressure for bonding and placing the talc pill;

the voltage and current sensor may be configured to measure a voltage and a current of the drive motor on the manipulator and control the operation of the manipulator;

the image acquisition device may be provided on the horizontal manipulator, and may include a camera with a visual tracking function.

Preferably, the actuator may include: the manipulator, a movable pulley and a feeding mechanism; the manipulator may be composed of the vertical manipulator, the horizontal manipulator and a vacuum adsorber; the movable pulley may include a main pulley that moves along a length of a workbench and an auxiliary pulley that is provided on the main pulley and moves along a width of the workbench;

the hardware processing module may include: a high-brightness and uniform LED light source, a filter and a hardware filter module; the high-brightness and uniform LED light source and the filter may be arranged on an upper part of the pulley;

the drive circuit may adopt a thyristor as a switch to control speeds of the drive motors, so as to control the movement speed of the manipulator;

the host computer may include: a display control screen and a remote control device; the display control screen may be configured to select a bonding mode and manually set a bonding movement trajectory of the talc pill when necessary; the remote control device may be configured for emergency shutdown and pause in case of failure.

The present disclosure has the following beneficial effects:

1) The intelligent control method and system of the present disclosure realize the fully automatic bonding of talc pills, and ensure the fastness and accuracy of the bonding of the talc pills.

2) Production results show that the bonding of the talc pills meets process standards and specifications, the talc pills are arranged neatly, and the bonding is of good quality.

3) The application of the present disclosure greatly improves production efficiency, and can completely replace manual operation.

### BRIEF DESCRIPTION OF THE DRAWINGS

In order to more clearly illustrate the specific embodiments of the present disclosure or the technical solutions in the prior art, the drawings needing to be used in the description of the specific embodiments or the prior art will be briefly described below. Apparently, the drawings in the following description show merely some embodiments of the present disclosure. Those of ordinary skill in the art may derive other drawings from these drawings without creative efforts, but such drawings should fall within the protection scope of the present disclosure.

FIG. 1 is a flowchart of an intelligent control method according to an embodiment of the present disclosure.

FIG. 2 is a flowchart of an image recognition method according to an embodiment of the present disclosure.

FIG. 3 shows a technical requirement for the bonding of a talc pill with upper and lower edges that are encrypted according to an embodiment of the present disclosure.

FIG. 4 is a schematic view of a fully automatic bonding system according to an embodiment of present disclosure.

FIG. 5 is a schematic view of a manipulator control method according to an embodiment of the present disclosure.

### DETAILED DESCRIPTION

The implementations of the present disclosure are described below in detail with reference to the drawings.

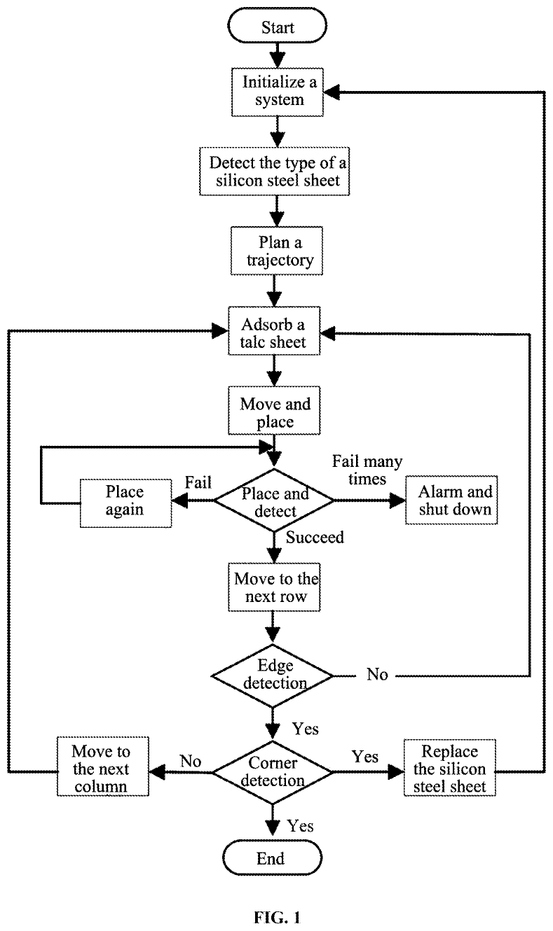

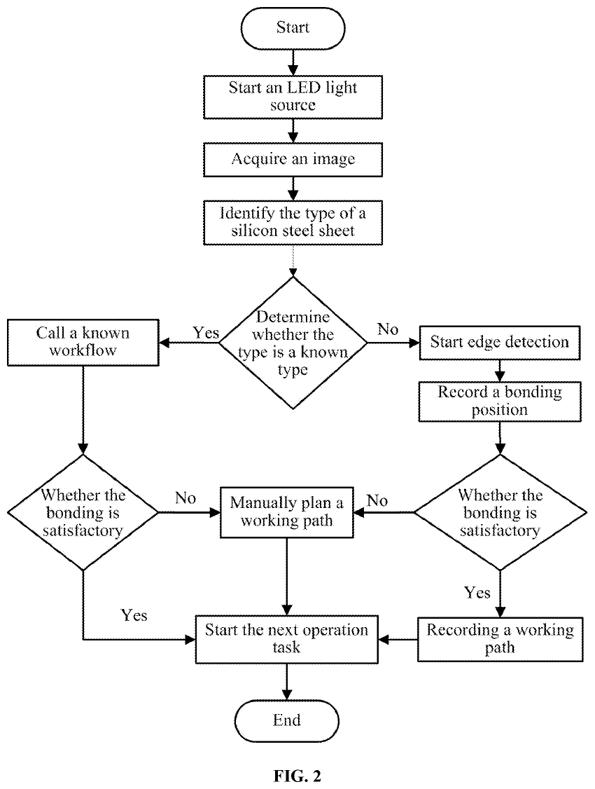

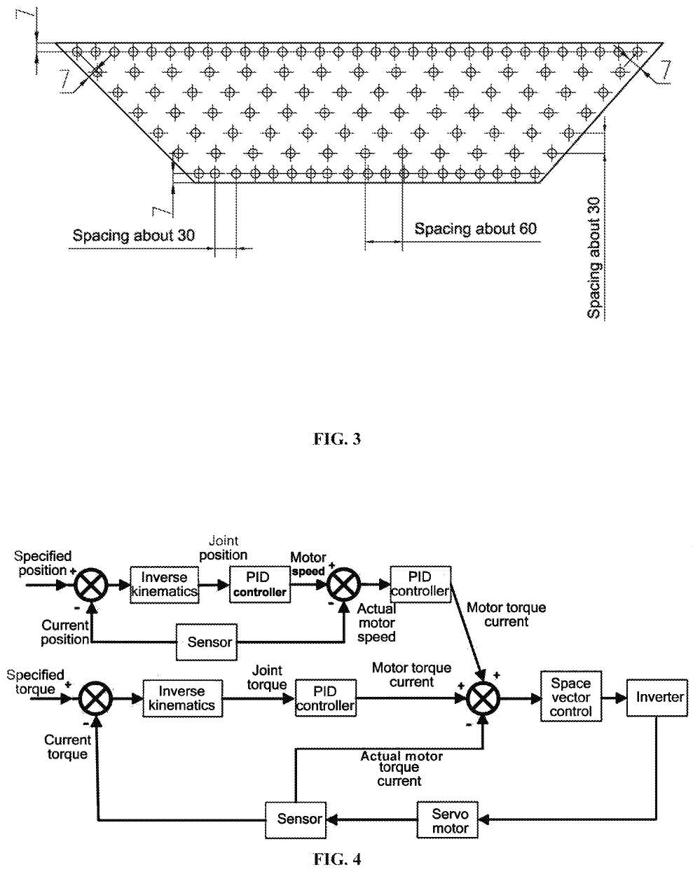

FIG. 1 is a flowchart of an intelligent control method according to an embodiment of the present disclosure. FIG. 2 is a flowchart of an image recognition method according to an embodiment of the present disclosure. FIG. 3 shows a technical requirement for the bonding of a talc pill with upper and lower edges that are encrypted according to an embodiment of the present disclosure. An intelligent control method for fully automatic bonding of a talc pill includes:

Step 1. Preliminary manual preparation:

An appropriate amount of talc pills and glue are placed into a barrel and a glue bucket respectively. A silicon steel sheet is put on a workbench, where silicon steel sheets with the same specifications and dimensions may be put in multiple layers. An upper edge of the silicon steel sheet is aligned with an upper positioning block to keep the silicon steel sheet perpendicular to a moving direction of an auxiliary pulley.

Step 2: Devices are started to enter an initialization phase. A vertical manipulator and a horizontal manipulator return to a mechanical zero position, and a vacuum adsorber moves to a fetching port. An operator may select different bonding modes through a host computer, and set a movement trajectory to complete the initialization of the system. There are two bonding modes according to different products, that is, an encrypted mode with upper and lower edges encrypted and a non-encrypted mode (default).

Step 3: A high-brightness and uniform light-emitting diode (LED) light source is started to acquire an image of the silicon steel sheet, and detect and identify the type of the silicon steel sheet.

An upper right sharp corner of the silicon steel sheet is placed into a camera shooting range of a visual identification mechanism. After the device is started, the type and specification of the silicon steel sheet are automatically determined through the image acquired by a camera. According to the type and specification of the silicon steel sheet, a corresponding bonding trajectory planning path of the talc pill is called.

Edge detection is performed on the silicon steel sheet according to the image to determine a position to place a first talc pill.

In this step, whether the identified specification and type of the silicon steel sheet are a known specification and type is determined. If yes, an existing bonding workflow is called for automatic bonding of the talc pills. If not, a new bonding workflow is set according to a new edge type of the silicon steel sheet, and the newly set bonding workflow is called for automatic bonding of the talc pills.

Step 4: The bonding of the first talc pill is automatically started until the bonding of a first column of talc pills is completed.

A single talc pill is conveyed through the vibration of the barrel to the fetching port via a spiral slideway and a linear slideway in sequence. The vertical manipulator drives the vacuum adsorber to go down under the action of a motor, and a suction nozzle adsorbs the talc pill up. A glue nozzle is driven by compressed air to spray an appropriate amount of glue up to the bottom of the talc pill and automatically suck excess glue back. The horizontal manipulator extends horizontally to move the talc pill to a position above the silicon steel sheet. The vertical manipulator drives the vacuum adsorber to press the talc pill down onto the silicon steel sheet. The talc pill is released and lifted up after a pressure is maintained for 200 ms, thereby completing the bonding of the first talc pill.

The manipulator moves to the next placement point based on a preset movement trajectory, and repeats the actions of fetching, spraying and pressing until a first column is completed. Edge detection is performed throughout the work process. When a machine vision system detects an edge, a control system issues a signal, and a programmable logic controller (PLC) automatically corrects a movement distance of the auxiliary pulley to ensure that the bonding position is 7 mm away from the edge.

In this step, whether a current talc pill is placed successfully is determined according to an acquired image. A maximum number of placements is set, for example, 5 times. An alarm is issued and the device is shut down if a number of placements exceeds the set maximum number of placements.

Step 5: The bonding of the following columns of talc pills is automatically started until the bonding of the talc pills of the entire silicon steel sheet is completed.

After completing the bonding of the first column of talc pills, a main pulley moves to a second column, and the auxiliary pulley automatically completes the bonding of the second column. The operations are repeated until the bonding of all the talc pills is completed. The bonding work is stopped when an end angle of the silicon steel sheet is detected. A buzzer sounds to remind an operator to take out the completed silicon steel sheet and place a new silicon steel sheet to continue bonding.

In order to handle exceptions in the bonding of the talc pills, an exception handling module is provided in this intelligent control method. The types of exceptions and corresponding handling methods are shown in the following table. In an embodiment of the present disclosure, the exception handling module may include one or more processors or chips having a communication interface capable of implementing a communication protocol, and may also include a memory and a related interface or system transmission bus when necessary. The processor or chip executes a program-related code to realize a corresponding function.

List of exception handling items of the control system

| Exceptions | Handling |
|---|---|
| Motor over-voltage | Alarm and shut down |
| Motor over-current | Alarm and shut down |
| A device goes beyond and edge of the | Alarm and shut down |
| silicon steel sheet | |
| The talc pill is not successfully | Re-fetch a talc pill |
| adsorbed or falls off | |
| The talc pill falls off many times | Alarm and shut down |
| Insufficient talc pills in the barrel | Alarm and shut down |
| The talc pill reaches and edge of the | Control the position of the talc |
| silicon steel sheet | pill to be 7 mm away from the |
| | edge |
| The talc pill reaches a corner | Alarm and shut down, and |
| | replace the silicon steel sheet |

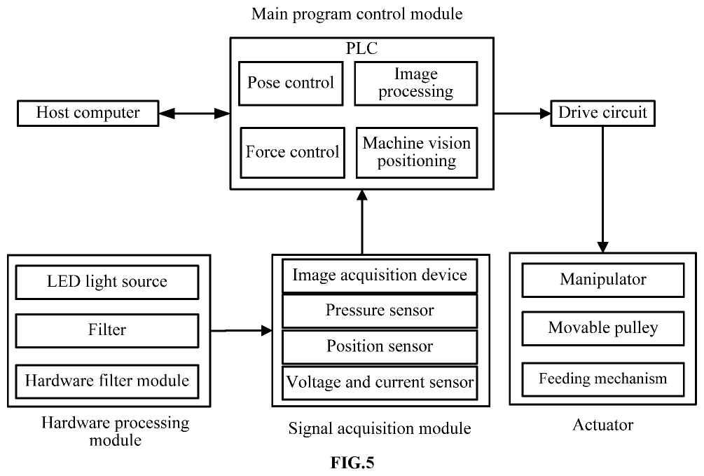

FIG. 4 is a schematic view of a fully automatic bonding system according to an embodiment of present disclosure. FIG. 5 is a schematic view of a manipulator control method according to an embodiment of the present disclosure. An intelligent control system for fully automatic bonding of a talc pill includes: a hardware processing module. The hardware processing module is electrically connected to a signal acquisition module to complete signal acquisition through hardware of the signal acquisition module. The signal acquisition module is electrically connected to a main program control module. The main program control module is electrically connected to a host computer and a drive circuit respectively. The drive circuit is electrically connected to an actuator. The host computer is provided to set the type of a silicon steel sheet, a bonding path of a talc pill and other parameters. The main program control module controls the action of a mechanical device of an actuator through the drive circuit according to real-time information acquired by the signal acquisition module, so as to complete the automatic bonding of the talc pill.

The main program control module includes: a PLC, an image processing and recognition module, a manipulator pose control module, a manipulator force control module and a machine vision positioning module. The image processing and recognition module is also referred to as an image recognition module. The manipulator automatic control module includes a manipulator pose control module and a manipulator force control module.

The PLC is configured to implement corresponding algorithms of the image processing and recognition module, the manipulator pose control module, the manipulator force control module and the machine vision positioning module. The PLC is provided on a main pulley to process various algorithms and signals, and is the core of the entire control system.

The image processing and recognition module processes an image acquired by a camera, obtains characteristic data through image processing, and determines the specification, type and an edge position of the silicon steel sheet, thereby determining an operation flow and a movement trajectory of a manipulator and a pulley.

The manipulator pose control module controls a horizontal manipulator to run stably to a specified position. By confirming the type of the silicon steel sheet and manually designing or checking a table to determine the corresponding movement trajectory, the movement of the manipulator is divided into horizontal movement and vertical movement. The horizontal movement mainly relies on manipulator pose control to ensure that the manipulator can accurately stay at a designated position. A position closed-loop control method and a feed-forward compensation method are adopted to ensure the rapid movement of the manipulator.

The manipulator force control module is mainly configured to control a vertical movement status of a vertical manipulator and control the vertical manipulator to ensure a stable output torque. A direct torque control algorithm is adopted to ensure the constant torque output of the manipulator, so as to ensure that the talc pill is firmly bonded, and effectively prevent the talc pill from falling off due to excessive pressure and prevent glue from overflowing due to excessive pressure.

The machine vision positioning module is mainly configured to determine an initial working position and a position to place the last talc pill in each row. The talc pill is controlled to be placed 7 mm away from an edge of the silicon steel sheet. According to the characteristics of corners of the silicon steel sheet, the placement position of a first talc pill is determined, and edge detection is performed at the last position, so as to place the talc pill 7 mm away from the edge. Since there is no need to measure the distance in a depth direction, only a single camera is required.

The drive circuit adopts a thyristor as a switch to control the speeds of the drive motors, so as to control the movement speed of the manipulator. The drive circuit amplifies a signal of the PLC and a movement signal of the manipulator, converts the control signal of the PLC into a drive signal of a drive motor on the manipulator, and controls a running status of the motor.

The signal acquisition module includes: an image acquisition device, a position sensor, a pressure sensor and a voltage and current sensor.

The position sensor is located at the drive motor of the manipulator and is provided coaxially with the drive motor. The position sensor is configured to feed back a current position of the manipulator to realize closed-loop control of the position of the manipulator, incrementally record a current movement distance by using an encoder and calculate the current position. The pressure sensor is configured to monitor the pressure of the manipulator on the silicon steel sheet so as to ensure the constant torque output of the motor. The pressure sensor is provided in the vertical manipulator, and is mainly configured to ensure a proper pressure for bonding and placing the talc pill. The PLC controls the operation status of the manipulator according to feedback information of the position sensor and the pressure sensor, thereby ensuring the accuracy of the bonding position of the talc pill, and ensuring a uniform force on the talc pill.

The voltage and current sensor is configured to measure a voltage and a current of the drive motor on the manipulator and control the operation of the manipulator, so as to ensure the speed and following performance of the manipulator. A current sensor in the voltage and current sensor is used for the manipulator drive motor to realize closed-loop control and over-current monitoring. A voltage sensor in the voltage and current sensor realizes motor phase voltage reconstruction and over-voltage monitoring.

The image acquisition device is provided on the horizontal manipulator, and includes a camera with a visual tracking function. It is mainly used to acquire the type of the silicon steel sheet. A high-brightness and uniform LED light source and a filter are used to optically process the silicon steel sheet, and a camera with a visual tracking system is used for image acquisition. All the above signal acquisition modules are connected to the PLC.

The actuator includes: the manipulator, a movable pulley and a feeding mechanism. The manipulator is composed of the vertical manipulator, the horizontal manipulator and a vacuum adsorber. The movable pulley includes a main pulley that moves along a length of a workbench and an auxiliary pulley that is provided on the main pulley and moves along a width of the workbench.

The hardware processing module includes: the high-brightness and uniform LED light source, the filter and a hardware filter module. The high-brightness and uniform LED light source and the filter are arranged on an upper part of the pulley to perform optical processing by means of hardware, so as to improve the recognition of an object, and cooperate with the image acquisition device to acquire clear images.

In the embodiment of the present disclosure, the hardware processing module is a hardware device including the high-brightness and uniform lighting LED light source, the filter and the hardware filter module. The hardware filter module may include one or more processors or chips with a communication interface capable of implementing a communication protocol. The processor or chip executes a program-related code to implement a corresponding function. The signal acquisition module is a hardware device including the image acquisition device, the position sensor, the pressure sensor and the voltage and current sensor. The main program control module is a hardware device including the PLC, the image processing and recognition module, the manipulator pose control module, the manipulator force control module and the machine vision positioning module. Specifically, it may be a controller with a communication interface capable of implementing a communication protocol. The image processing and recognition module, the manipulator pose control module, the manipulator force control module and the machine vision positioning module are integrated in the PLC, and the PLC executes a program-related code to realize a corresponding function. The image recognition module is an image processing and recognition module, and the manipulator automatic control module includes the manipulator pose control module and the manipulator force control module. Therefore, the image recognition module and the manipulator automatic control module can be integrated into one controller with a communication interface capable of implementing a communication protocol. The controller executes a program-related code to realize a corresponding function.

The host computer includes: a display control screen and a remote control device. The display control screen is mainly configured to select a bonding mode and manually set a bonding movement trajectory when necessary. The remote control device is configured for emergency shutdown and pause in case of failure. The host computer is separated from the PLC, which is convenient for the operator to issue a command to the control system to plan a movement trajectory for bonding.

Finally, it should be noted that the above are merely specific implementations of the present disclosure, which are intended to illustrate the technical solutions of the present disclosure, rather than to limit the protection scope of the present disclosure. Those skilled in the art should understand that, within the technical scope disclosed in the present disclosure, any person skilled in the art may modify or easily think of changes to the technical solutions described in the above embodiments, or equivalently replace some of the technical features. These modifications, changes or replacements may not cause the essence of the corresponding technical solutions to deviate from the spirit and scope of the technical solutions of the embodiments of the present disclosure, and should be covered within the protection scope of the present disclosure.

1. An intelligent control method for fully automatic bonding of a talc pill, comprising:
automatically identifying, by an image recognition module, a specification and type of a silicon steel sheet to be processed, calling a corresponding bonding trajectory planning path of a talc pill according to the specification and type of the silicon steel sheet, and automatically bonding, by a manipulator automatic control module, the talc pill to a corresponding position on the silicon steel sheet according to the bonding trajectory planning path.

2. The intelligent control method for fully automatic bonding of a talc pill according to claim 1, wherein the automatically identifying, by an image recognition module, a specification and type of a silicon steel sheet to be processed, calling a corresponding bonding trajectory planning path of a talc pill according to the specification and type of the silicon steel sheet, and automatically bonding, by a manipulator automatic control module, the talc pill to a corresponding position on the silicon steel sheet according to the bonding trajectory planning path specifically comprises:
step 1: preliminary manual preparation: placing talc pills, glue and the silicon steel sheet in position;
step 2: starting devices of an intelligent control system for fully automatic bonding to complete initialization of the system;
step 3: starting a high-brightness and uniform light-emitting diode (LED) light source to acquire an image of the silicon steel sheet, detecting and identifying the specification and type of the silicon steel sheet, calling a corresponding bonding trajectory planning path of each of the talc pills according to the specification and type of the silicon steel sheet, and performing edge detection on the silicon steel sheet according to the acquired image to determine a position to place a first talc pill;
step 4: automatically starting the bonding of the first talc pill until the bonding of a first column of talc pills is completed; and
step 5: automatically starting the bonding of the following columns of talc pills until the bonding of the talc pills of the entire silicon steel sheet is completed.

3. The intelligent control method for fully automatic bonding of a talc pill according to claim 2, wherein step 3 further comprises: determining whether the identified specification and type of the silicon steel sheet are a known specification and type; if yes, calling an existing bonding workflow for automatic bonding of the talc pills; and if not, setting a new bonding workflow according to the new specification and type of the silicon steel sheet, and calling the newly set bonding workflow for automatic bonding of the talc pills.

4. The intelligent control method for fully automatic bonding of a talc pill according to claim 3, wherein step 4 further comprises: conveying a single talc pill through a vibration of a barrel to a fetching port via a spiral slideway and a linear slideway in sequence; driving, by a vertical manipulator, a vacuum adsorber to go down under the action of a motor, and adsorbing, by a suction nozzle, the talc pill up; driving, by compressed air, a glue nozzle to spray quantitative glue up to the bottom of the talc pill and automatically suck excess glue back; extending a horizontal manipulator horizontally to move the talc pill to a position above the silicon steel sheet; driving, by the vertical manipulator, the vacuum adsorber to press the talc pill down onto the silicon steel sheet; and releasing the talc pill after maintaining a pressure for 200 ms, thereby completing the bonding of the first talc pill.

5. The intelligent control method for fully automatic bonding of a talc pill according to claim 4, wherein step 4 further comprises: determining whether a current talc pill is placed successfully according to an acquired image; setting a maximum number of placements; and alarming and shutting down if a number of placements exceeds the set maximum number of placements; step 5 further comprises: stopping the bonding work when an end angle of the silicon steel sheet is detected; and sounding a buzzer to remind an operator to take out the completed silicon steel sheet and place a new silicon steel sheet to continue bonding.

6. The intelligent control method for fully automatic bonding of a talc pill according to claim 5, further comprising: setting an exception handling module; wherein the exception handling module is configured to: alarm and shut down if a motor is over-voltage, over-current, or a mechanical device goes beyond an edge of the silicon steel sheet, or the talc pill falls off for many times, or the talc pills in the barrel are insufficient; re-fetch a talc pill if the talc pill is not successfully adsorbed or falls off; and control the placement of the talc pill to meet a distance value from the edge of the silicon steel sheet if the talc pill reaches the edge.

7. An intelligent control system for fully automatic bonding of a talc pill, applying the intelligent control method for fully automatic bonding of a talc pill according to claim 1, and comprising: a hardware processing module, wherein the hardware processing module is electrically connected to a signal acquisition module; the signal acquisition module is electrically connected to a main program control module; the main program control module is electrically connected to a host computer and a drive circuit respectively; the drive circuit is electrically connected to an actuator.

8. The intelligent control system for fully automatic bonding of a talc pill according to claim 7, wherein the main program control module comprises: a programmable logic controller (PLC), an image processing and recognition module, a manipulator pose control module, a manipulator force control module and a machine vision positioning module;
the PLC is provided on a main pulley, and is configured to implement corresponding algorithms of the image processing and recognition module, the manipulator pose control module, the manipulator force control module and the machine vision positioning module;
the image processing and recognition module is configured to acquire characteristic data through image processing, and determine the specification, type and an edge position of the silicon steel sheet;
the manipulator pose control module is configured to control a horizontal manipulator to run stably to a specified position;
the manipulator force control module is configured to adopt a direct torque control algorithm to control a vertical movement status of a vertical manipulator and control the vertical manipulator to ensure a stable output torque;
the machine vision positioning module is configured to determine an initial working position and a position to place the last talc pill in each row.

9. The intelligent control system for fully automatic bonding of a talc pill according to claim 8, wherein the signal acquisition module comprises: an image acquisition device, a position sensor, a pressure sensor and a voltage and current sensor;
the position sensor is located at a drive motor of a manipulator and is provided coaxially with the drive motor; the position sensor is configured to feed back a current position of the manipulator to realize closed-loop control of the position of the manipulator, incrementally record a current movement distance by using an encoder and calculate the current position;
the pressure sensor is provided in the vertical manipulator, and is configured to ensure a proper pressure for bonding and placing the talc pill;
the voltage and current sensor is configured to measure a voltage and a current of the drive motor on the manipulator and control the operation of the manipulator;
the image acquisition device is provided on the horizontal manipulator, and comprises a camera with a visual tracking function.

10. The intelligent control system for fully automatic bonding of a talc pill according to claim 9, wherein the actuator comprises: the manipulator, a movable pulley and a feeding mechanism; the manipulator is composed of the vertical manipulator, the horizontal manipulator and a vacuum adsorber; the movable pulley comprises a main pulley that moves along a length of a workbench and an auxiliary pulley that is provided on the main pulley and moves along a width of the workbench;
the hardware processing module comprises: a high-brightness and uniform LED light source, a filter and a hardware filter module; the high-brightness and uniform LED light source and the filter are arranged on an upper part of the pulley;
the drive circuit adopts a thyristor as a switch to control speeds of the drive motors, so as to control the movement speed of the manipulator;
the host computer comprises: a display control screen and a remote control device; the display control screen is configured to select a bonding mode and manually set a bonding movement trajectory of the talc pill when necessary; the remote control device is configured for emergency shutdown and pause in case of failure.
